(19) United States
(12) Patent Application Publication
(10) Pub. No.: US 2006/0283977 A1
(43) Pub. Date: Dec. 21, 2006

(54) Novel cryogenic firefighting and hazardous materials suppression apparatus

(76) Inventor: Leo Spitz Macdonald, Stroudsburg, PA (US)

Correspondence Address: HESLIN ROTHENBERG FARLEY & MESITI PC, 5 COLUMBIA CIRCLE, ALBANY, NY, 12203, US

(21) Appl. No.: 11/157,039

(22) Filed: Jun. 20, 2005

(51) Int. Cl. B05B 1/28

(52) U.S. Cl. 239/288; 239/569

(57) ABSTRACT

A cryogenic firefighting and hazardous materials suppression apparatus has been invented. It is intended for use by firefighting personnel in combating fires and hazardous materials spills. The apparatus comprises several components including a cryogenic fluid dispensing device, said device removably connected to a cryogenic fluid supply conduit, said conduit removably connected to a storage vessel, said vessel storing an agent for delivery. Said agent may be an inert cryogenic liquid. Said apparatus being used for delivering said agent on to a target. Such targets that may be appropriate include fires and hazardous materials spills.

### TECHNICAL FIELD

This invention is directed to the art of controlling hazardous events, including fires, spills, and chemical releases.

### BACKGROUND OF THE INVENTION

The many paid and volunteer fire departments, the police departments, and other government agencies are often called upon to respond to out-of-control events. Generally, these out-of-control events are emergencies, including fires, spills, and chemical releases of a variety of types. These out-of-control fires, spills, and chemical releases may occur in the wild lands, as well as in rural, residential, commercial, and industrial areas. Most fires are extinguished by firefighters who use water delivered at high pressure through large hoses and nozzles. The delivered water cools the burning materials (wood, plastic, etc.) through endothermic evaporation, and gradually extinguishes the fire. Structural fires often take a substantial time to extinguish and often the water does not extinguish the fire until a significant portion of the structure has been destroyed. Furthermore, the portion of the structure that survives the fire often has serious water damage requiring extensive renovation and repair. Water damage is particularly costly in buildings where large quantities of paper records, rare artwork, and/or computers are kept. Other kinds of sensitive equipment are also heavily damaged by water.

Fires in commercial or industrial areas often take the form of hazardous materials fires. These areas include such venues as tire warehouses, junkyards, chemical factories, gasoline stations, tanks or vats of organic liquids (e.g., crude or distillate oils), motor vehicles, tanker trucks or trains, airplanes, oil-well pump heads, fuel refineries, and others. These fires are typically very difficult to extinguish using water and standard fire engines/pumpers. The fires will often burn hotly enough that they cannot be cooled below the ignition point by the application of water. Also, many flammable liquids, such as gasoline, will float on water so that the fire will continue to burn, and will actually be spread by the water to enlarge the fire. Flammable metals, such as magnesium, are extremely difficult to extinguish because of their very high heat of combustion and their reactivity towards water. Airplane fires are also especially dangerous, due to the huge volume of easily combustible fuels present that forms explosive mixtures with air.

Hazardous materials fires occur more and more frequently as today's high paced society dictates the wide scale use of motor vehicles, flammable fuels, tires, chemical factories, airplanes etc. Additionally a variety of extremist groups have used, and continue to use fire and explosives as terrorist weapons to inflict significant and widespread damage throughout society.

Today's firefighters already risk their lives while attempting to put out typical residential structural fires. An increasing percentage of emergency calls are for these hazardous materials fires. Furthermore, hazardous materials fires cause large amounts of damage because they often burn for several days and consume the whole initial structure as well as adjacent structures. Additionally these fires are quite expensive to put out because several to several dozen fire companies will typically respond. Large events cause in excess of a hundred engines, pumpers, hose trucks, ladder trucks, and the like to turn out. Quite often, these fires cause buildings to collapse which can result in fatalities. Large financial damages are incurred by several groups, including building owners, insurance companies, fire companies, tenants, company shareholders, neighbors, and others.

Another type of alarm state is a hazardous materials spill incident. During a spill, any of a variety of hazardous chemicals may be released into the environment, thereby endangering nearby people, residential areas, plants, and animals in the environment. In these types of spills these is a significant difference in the properties of the spilled materials. Liquid spills are defined as liquids that do not evaporate or boil at temperatures below 100 degrees C., while volatile liquid spills are defined as liquid releases which do evaporate or boil below 100 degrees C., and gaseous releases are defined as a release of a substance that exist as a vapor at temperatures above 0 degrees C. Thus liquid spills will tend to stay as a liquid, while volatile liquid spills will tend to evaporate and create a vapor cloud around the liquid, while gaseous releases will form only an airborne cloud. Containing and cleaning up these spills and releases are quite difficult. The most difficult to contain are gaseous releases, such as chlorine, hydrochloric acid, ammonia, natural gas (methane), and others. These airborne clouds can drift for several miles before dispersing to safe levels. There is no safe way to collect and neutralize these hazardous clouds currently. The other major type of hazardous materials release is that of a liquid spill. The more dangerous liquids are volatile liquids, such as gasoline, motor oil, ether, solvents, petroleum distillates, alcohol, acetone, and others. These spills are very hazardous due to their propensity to evaporate and form a low lying vapor cloud, which often will catch fire via a vapor flash from surrounding sources of ignition, such as sparks, running or hot engines, electrical supply devices, and others. Other liquid releases include such chemicals as acids (e.g. sulfuric, nitric, hydrochloric acids), oxidizers (e.g. bleach, perchloric acid), and other toxic or hazardous liquids. Currently the spilled liquids are absorbed onto media such as diatomaceous earth, sand, and/or sponges. The absorbent material is stored, and can be hazardous, taking on similar properties to the absorbed liquid, including being flammable, corrosive, etc. If the spills are large, the spilled material is contained through the construction of dykes. These methods of containment represent temporary measures of control, as the hazardous material still needs to be neutralized. Most hazardous materials spills are dealt with in an inadequate manner today, allowing for continued hazard within the spill area and continued potential for contamination of the surrounding area.

A variety of technologies exist, and are in use, for controlling fires, spills, and chemical releases. Some of these technologies include such agents as water, Aqueous Film Forming Foam (AFFF), foam, dry chemical powders such as sodium/potassium carbonate or bicarbonate, carbon dioxide (CO₂), Halon, Purple K (dry chemical mixture), water mist/vapor spray, sand or dirt for smothering, absorbent chemicals and dry media such as sand, diatomaceous earth, and others. The technology of using inert gasses disposed from a cryogenic liquid source as a firefighting agent has been previously disclosed. These systems have been researched throughout the 20th century, as the technology for manufacture and use of liquefied gasses (e.g. cryogenics) has developed. The prior art has exhibited a variety of problems, issues, and drawbacks which have prevented their acceptance and use. The prior systems described often take the form of a permanent installation attached to a building, thereby limiting the usage to just that structure. Some other systems described have been quite complex, bulky, and difficult to transport to the location where they are needed, thereby preventing acceptance and usage by fire departments. Often many operators are required; and the control of the apparatus is a complex and difficult job, in some cases requiring the use of large turbines, pumps, combustion chambers, mixing of toxic or corrosive liquids and gases, or other burdensome equipment or procedures. These large, complex, and/or otherwise immobile setups have very high costs as an additional drawback. Other prior teachings include the usage of explosive devices as a means of activating a fire extinguishing charge, or the use of an explosive device as an extinguishing media. The use of explosives is inherently dangerous, such that few, if any, firefighters want to use them. Additionally, the usefulness of igniting a high energy incendiary device within an existing structural fire is quite suspect, in as much as a high energy explosion may actually make the overall conflagration much worse. This is especially true when applied to a volatile liquid fire such as a burning tanker of gasoline. Such practices with explosives have been used successfully in wartime to ignite and burn whole cities.

These above described firefighting technologies often have shortcomings rendering them ineffectual. Often a hazardous materials fire will burn for several days in spite of the application of one or more of these agents. Additionally these chemical agents each have a set of shortcomings such that no one agent is effective against all hazardous materials fires and chemical spills. These shortcomings include the inability to cool a fire rapidly, failing to prevent air from reaching a fire, being unable to reduce the hazardous nature of a chemical spill, the inability to neutralize toxic or corrosive gas clouds, failing to protect an area from additional damage, being difficult to clean up afterwards, being harmful to the environment, and being harmful to people and animals.

It is therefore apparent that the invention and production of a novel fire extinguisher that would be more effective in combating hazardous materials fires, spills, and chemical releases, would be welcome in the art.

### SUMMARY OF THE INVENTION

A novel cryogenic firefighting and hazardous materials suppression apparatus has been invented. The current invention, said apparatus is more effective in combating fires, spills, and chemical releases than prior technologies have been, and is especially effective against hazardous materials fires and hazardous materials spills.

This current invention is a novel cryogenic firefighting and hazardous materials suppression apparatus which comprises a cryogenic fluid dispensing device, a cryogenic fluid dispensing system, and a method for dispensing a cryogenic fluid upon a target. The physical apparatus comprises at least; a cryogenic fluid dispensing device; removably connected to a cryogenic supply conduit; said conduit removably connected to a cryogenic liquid storage vessel, said vessel containing an agent. In an embodiment, said agent is an inert cryogenic liquid. The cryogenic fluid dispensing device allows an operator to control and dispense the agent onto a target. This apparatus incorporates additional features described below in the detailed description of the invention.

The current invention has many benefits. It has a greater ability to extinguish fires than many other extinguishers, especially in the area of hazardous materials fires. The cryogenic agent has a unique property of cleaning itself up after the fire is extinguished through evaporation. The agent is benign to other objects such as a building structures, equipment, computers, books, paper files, and other sensitive objects. The agent is not damaging to the environment. The current apparatus can be easily integrated with the current fire fighting equipment and procedures and operated by current fire fighters with minimum additional training. Additionally said apparatus is compact and mobile to allow facile deployment to the scene of an emergency. The described apparatus can extinguish every kind of fire that requires heat and air to burn, by simultaneously cooling the burning materials and excluding air from the vicinity of the fire. Additionally this apparatus can stop any type of liquid spill by freezing liquids (acids, caustics, organic fuels, etc.) into solids, even while the liquids are flowing from a crack in a tank, or through a leaky valve. The leak will be stopped by the frozen plug of material and a more permanent patch can then be safely applied. Additionally many types of gaseous spills may be suppressed by cooling the hazardous gases into liquids or solids and collecting them in containers, thereby preventing the spread and diffusion of the noxious cloud.

The current invention, a cryogenic firefighting and hazardous materials suppression apparatus, is composed of a multiplicity of components. These components include a device, a system, and a usage methodology.

Said cryogenic fluid dispensing device comprises: a hollow cylindrical body having a first end and a second end; means for mounting a cryogenic fluid supply conduit to the first end; a dispensing nozzle mounted to the second end; a valve positioned in the hollow cylindrical body between the first end and the second end; and a thermally insulating barrier at least partially surrounding the hollow cylindrical body.

Said cryogenic fluid dispensing system comprises: a source of cryogenic fluid; at least one supply conduit having a first end operatively connected to the source of cryogenic fluid and a second end; at least one cryogenic fluid dispensing device comprising: a hollow cylindrical body having a first end operatively connected to the second end of the supply conduit and a second end; a dispensing nozzle mounted to the second end; a valve positioned in the hollow cylindrical body between the first end and the second end; and a thermally insulating barrier at least partially surrounding the hollow cylindrical body.

Said method for dispensing a cryogenic fluid upon a target, the method comprising: providing a source of cryogenic fluid; providing a cryogenic fluid dispensing device comprising: a hollow cylindrical body having a first end operatively connected to the source of cryogenic fluid and a second end; a dispensing nozzle mounted to the second end; and a valve positioned in the hollow cylindrical body between the first end and the second end; supplying a flow of cryogenic fluid from the source of cryogenic fluid to the cryogenic fluid dispensing device; controlling the flow of cryogenic fluid through the dispensing device by means of the valve; and directing the flow of fluid out of the dispensing nozzle toward the target. Said target being one of a fire and a hazardous material. Other details regarding the various embodiments of this novel cryogenic firefighting and hazardous materials suppression apparatus are provided later in the specification.

### BRIEF DESCRIPTION OF FIGURES

Several embodiments of the novel cryogenic firefighting and hazardous materials suppression apparatus are presented. These are to be construed as illustrative examples and not as any sort of limitation on the scope of the current invention. A person trained in the art is able to understand these descriptions and that a variety of possible modifications are within the scope and coverage of this invention.

FIG. 1 is a plan view, partially in cross section, of an embodiment of a cryogenic fluid dispensing device.

FIG. 2 is a cross sectional view of the device shown in FIG. 1 through the indicated view A-A in FIG. 1.

FIG. 3. is a plan view of an embodiment of a cryogenic fluid dispensing system.

FIG. 4 is plan view of a manifold.

FIG. 5 is an aerial view of an embodiment of a cryogenic fluid dispensing system.

### DETAILED DESCRIPTION OF THE INVENTION

The current invention provides a simple, easy to use, effective, and safe system for extinguishing fires and containing hazardous material spills. Furthermore, the current invention has many additional advantages that make it unique among firefighting and hazardous material spill suppression systems.

As used herein, “agent” refers to a substance, material, and/or chemical that is delivered through the apparatus onto the target. Said agent is typically a fluid, said fluid may be a liquid or a gas, and may be a cryogenic liquid. The term “cryogenic liquid” is defined as a gas that has been liquefied through cooling. These cryogenic liquids are elements and compounds that are in the gaseous state at normal atmospheric pressure (760 mmHg) and temperature (−30 degrees C. to +50 degrees C.). The exact temperature of the liquefaction points and the temperature of the resulting metastable cryogenic liquid depends on the composition of the gases. Various gases have boiling points ranging from −34 degrees C. down to as low as −269 degrees C. The term “inert cryogenic liquid” refers to one or more of a family of cryogenic liquids that have very limited or no reactivity, especially when subjected to high temperatures and reactive environments. The agents used herein may be any of a large family of inert cryogenic liquids. These include xenon, which has a boiling point (bp)=−108 degrees C., krypton (bp=−153 degrees C.), argon (bp=−185 degrees C.), neon (bp=−246 degrees C.), helium (bp=−269 degrees C.), carbon dioxide (sublimation point (sp)=−78.5 degrees C.), and nitrogen (bp −196 degrees C.). For convenience, helium, nitrogen and argon are all supplied as cryogenic liquids in tanks via commercial gas supply companies. Several other commercially available cryogenic liquids are not inert. Their use may be detrimental in firefighting but could be effective in stopping some types of spills. These include hydrogen (bp=−252 degrees C.), oxygen (bp=−182 degrees C.), methane or liquefied natural gas (LNG) (bp=−161 degrees C. to −88 degrees C.), radon (bp=−62 degrees C.), fluorine (bp=−188 degrees C.), chlorine (bp=−34 degrees C.), carbon monoxide (bp=−191 degrees C.) and others. Additional agents which may be used include mixtures of various fluids, such as water in nitrogen, bromoform in polybromoethylene, various chlorofluorocarbons, nitrogen with argon, and others.

This novel cryogenic firefighting and hazardous materials suppression apparatus is composed of a multiplicity of components. These components include a device, a system, and a usage methodology. These components allow a single operator to safely contain, deliver, control, and dispense an inert cryogenic agent onto a particular target, such as a fire or a hazardous material spill. The components comprising said system include; a cryogenic fluid dispensing device, a cryogenic supply conduit, and a vessel for containing an agent, said agent may be an inert cryogenic liquid. The methodology of use is the steps that an operator performs to utilize the apparatus for effective firefighting and hazardous materials suppression.

A component of the current invention is the cryogenic fluid dispensing device, hereafter called a cryogenic gun. This cryogenic gun has many unique features and is composed of several parts. The cryogenic gun affords an individual operator complete control over the delivery an inert cryogenic liquid. The gun is simple to use and durable. In order to withstand the extreme temperatures of cryogenic liquids, the components of the apparatus are composed of materials that have uniform thermal contraction.

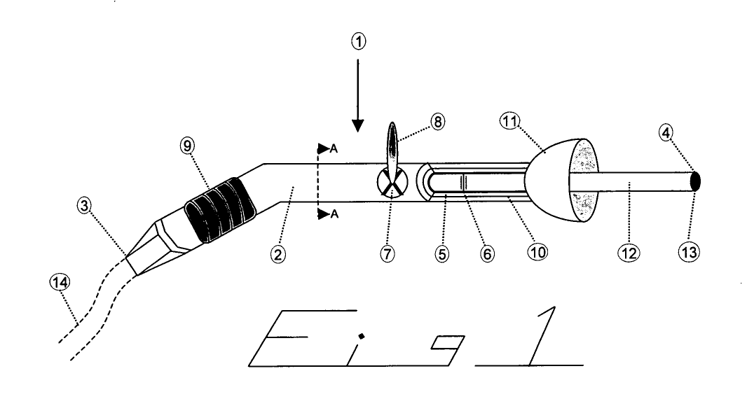

One embodiment of this cryogenic fluid dispensing device is described by referring to the figures, in particular: FIG. 1. The cryogenic gun 1 is shown. The gun 1 is comprised of a hollow cylindrical body 2 having a first end 3 and a second end 4. The first end 3 is a fitting and may be of a variety of types, one example of such a fitting is a national pipe thread (NPT) fitting. The first end 3 is removably connected to a cryogenic fluid supply conduit 14. The body 2 is composed of sections of tubing 5, which may be bent or straight and which are joined by coupling fittings 6 to form a continuous liquid tight length. In an embodiment the tubing 5 is metal, specifically stainless steel (alloy 304). Additional materials could be used including other stainless steel alloys, copper, steel, brass, titanium, nickel alloys, ceramics, composites, or any of a variety of other materials.

Mounted within the body 2 of the gun 1, between the first end 3 and the second end 4, is a valve 7. In an embodiment, the valve 7 is a ball valve and is composed of stainless steel in the body, and the handle, and the ball. A variety of other types of valves may be used, including a gate valve, globe valve, piston valve, needle valve, and any one of several others. The valve 7 may have specific opening and closing speeds, where such speeds are either of the fast acting type, taking less than two seconds to complete a stroke (open or shut), or of the slow acting types, taking longer than two seconds to complete a stroke. A variety of materials for construction of the valve 7 may be used, including metals such as stainless steel, steel, brass, copper, titanium, as well as ceramics, composites and other materials. The valve 7 contains a handle 8, which may be mounted in a variety of ways and is shown in a representative position. In an embodiment the valve handle 8 is ambidextrous. The body 2 of the gun 1 also incorporates at least one handle 9 mounted onto the body 2, between the first end 3 and the valve 7. An additional handle may be mounted in other locations along the body 2. More than one handle may be incorporated to fit a variety of hand positions. More than one handle also allows more than one operator to handle the cryogenic gun 1 simultaneously.

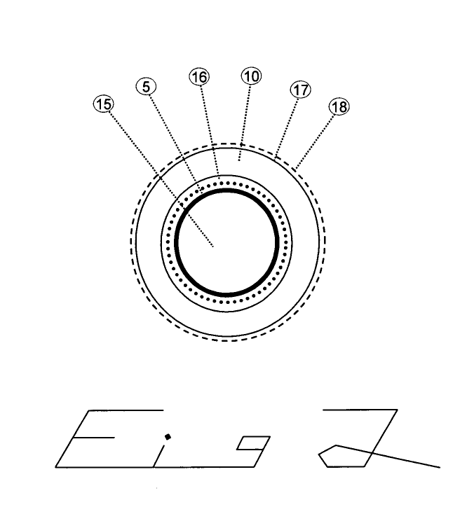

In order to protect the operator from the cryogenic temperatures, the cryogenic gun 1 is at least partially surrounded with a thermally insulating barrier 10 comprising at least one layer of insulation. A cross section of the gun 1 through A-A is shown in FIG. 2, and details of the at least one insulating layer are described later on. In order to protect the operator from the flow of the cryogenic agent, the gun 1 contains a shield 11 in front of the valve 7. In an embodiment, the shield 11 is hemispherical with the open end facing away from the user. The shield 11 may be a variety of other shapes as well, including flat, conical, pyramidal, or having several sides or being other shapes.

The outlet of the gun 1 is a nozzle 12 which is affixed in front of the shield. The nozzle may incorporate an orifice 13 through which the agent is dispensed. Said nozzle and orifice form the second end 4 of the gun 1. The nozzle 12 and orifice 13 can have a variety of lengths and shapes, including many internally and externally disposed components, including, holes, passageways, pins, screens, screws, helices, and/or protrusions, and may be pointed, squared off, bell shaped, having an inverted bell shape, rifled, chamfered or beveled, and choked in order to direct and channel the flow of the agent.

In an embodiment, a pressure regulator may be incorporated. Typically it is incorporated between the valve 7 and the shield 11, although it may be incorporated anywhere within the body 2 of the gun 1. The regulator can control the pressure of the liquid within the gun 1. The body 2 of the gun 1 may also incorporate several other features, such as additional nozzles, regulators, venturi devices, secondary shutoffs, mixing chambers, inlet Tee(s), a deadmans shutoff switch, spring loaded valves, hydraulic actuators, pneumatic controls, electrical controls, and other components.

The cryogenic gun is shown in cross section in FIG. 2, said cross section taken through indicated location A-A in FIG. 1. At the center, is a hollow passageway 15 through which the agent travels. Around this passageway 15 is the tubing 5 which comprises the body 2 of the gun 1. The first layer around the tubing 5 is an adhesive layer 16. In an embodiment, the adhesive 16 used is a tape that is wound in a reverse twist helical pattern to increase the surface area and bonding of the insulation 10 to the tubing 5. Alternatively, a reverse twist double counter-rotating helix of adhesive 16 tape may be used to further increase bonding. Alternatively, a liquid adhesive 16 could be applied by painting on, spraying on, or dipping.

An additional layer around the tubing is a thermally insulating barrier 10, including at least one layer of insulation. This insulation 10 could be composed of any low-thermal-conductivity medium including vacuum, wood, mylar, oxide ceramic blankets such as fiberglass or aluminum oxide, pearlite, or any of a plethora of other insulating media. In an embodiment the insulation 10 used is aluminum oxide blanket. The insulation 10 may comprise many layers of alternating materials. An embodiment of alternating layers is to incorporate several layers of mylar and alumina, or alumina and glass tape and aluminum, or plastic and fiberglass, or vacuum and rigid metal shells, or alternate insulating media.

An additional layer is a protective and durable sheathing 17, typically a metal. In an embodiment, a composite fiberglass and aluminum tape is used as sheathing 17. Additionally the sheathing 17 could be rigid plastic, metal, or ceramic, as cast from a mold or machined to a covering shape. An additional layer is a heavy wire helical overwrap 18 to bind the many layers together and give the whole unit strength through compression as well as protection from abrasion. Several additional layers may be added. An external layer comprising a rigid shell made of metal or wood may be used. Additionally repetitions of the above described layers, in order to decrease the thermal transfer from the cryogenic agent to the operator and to increase the durability of the cryogenic gun as a whole may be incorporated.

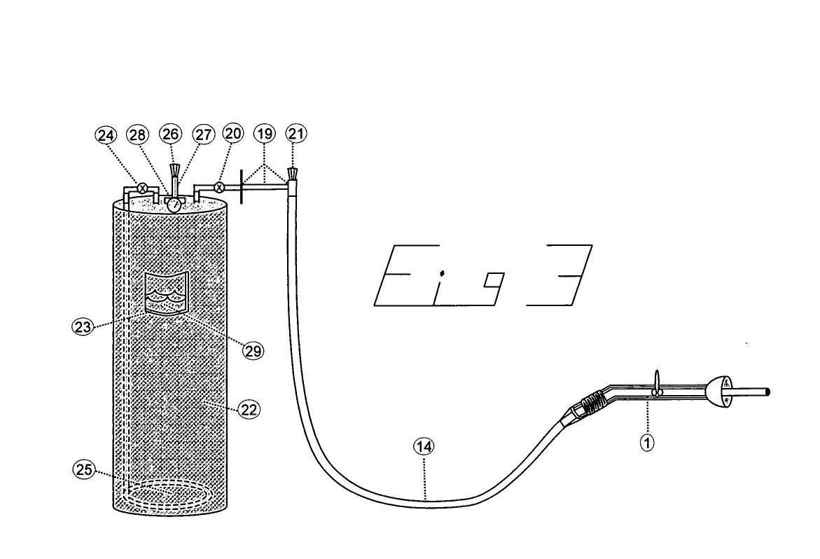

An embodiment of a cryogenic firefighting and hazardous materials suppression system is shown in FIG. 3. The system includes an apparatus which is comprised of several components. The cryogenic gun 1, as shown in FIG. 1, is removably connected to a cryogenic fluid supply conduit 14. The conduit 14, typically called a hose 14, is comprised of a series of concentric stainless steel members that form a liquid tight passageway, surrounded by a protective overwrap, and covered by a hard armor casing. The hose 14 may also contain an insulating layer, such as vacuum or an oxide blanket. The hose 14 can be a variety of lengths, ranging from one foot to thousands of feet. This hose 14 may be stored in a variety of ways, including coiling, stacking, winding on a reel, and other ways. The hose 14 is connected through a fitting assembly 19 to a valve 20. Often this fitting assembly 19 requires a tool to securely fasten. In an embodiment, this fitting assembly 19 is a special fitting that does not require tools to securely fasten. The fitting assembly 19 also incorporates a pressure relief valve 21 to prevent accidental hose rupture. Said valve 20 is attached to a vessel 22 for containing the agent 29. Said valve 20 is used to enable or disable the flow of fluid through said valve 20. The valve 20 may be a manual shutoff type. Said valve 20 may be one of a variety of types of valves including a ball valve, gate valve, globe valve, piston valve, needle valve, and any one of several others. Said valve 20 may be composed of a variety of materials including metals such as stainless steel, steel, brass, copper, titanium, nickel alloys, as well as ceramics, composites and other materials

This vessel 22 is most commonly a cylindrical tank. The tank 22 may be secured to a stand or to a vehicle by straps, hooks, bands, gravity, etc. The tank 22 may be a variety of sizes, from small 20-gallon units to larger than 10,000-gallon units. The tank 22 may be positioned as having the long axis either horizontal or vertical, or some combination thereof. Additionally the tank 22 may be spherical. The tank 22 is typically metallic, often manufactured of stainless steel. A variety of other materials may be used for construction, including steel, aluminum, titanium, composite materials, and ceramics. The tank 22 is shown, with a cutaway view, to be double-walled 23, said double-walls having vacuum insulation between them. A variety of other insulating materials may also be used, such as various metal-oxide blankets, ceramics, pellets, plastics, sol-gels, etc. The tank contains a plurality of attached valves. One of these valves 20 is for dispensing the agent into the removably connected cryogenic fluid supply conduit 14.

Another valve 24 operates the internal pressurization circuit 25. This pressurization circuit 25 may operate via evaporation, electric heaters, gaseous injection, or other means. This pressurization circuit 25 serves to keep the tank at a pressure greater than the atmospheric pressure such that the fluid is forced from the tank 22 and through the supply conduit 14 to the dispensing device 1. The tank 22 has an overpressure relief valve 26 in order to prevent accidental tank rupture. The tank 22 also has a liquid level indicator 27 and a pressure gauge 28. Additionally some tanks have a gas dispensing valve.

The tank 22 contains an agent 29. The agent 29 can be any one of a variety of chemical fluids. These fluids may be liquid or gaseous in nature. Water may be used, as well as foams, powder slurries, non-flammable oils, cryogenic liquids, and other fluids. In the preferred embodiment, the agent 29 is an inert cryogenic liquid, chosen from the family of inert cryogenic liquids including helium, neon, argon, krypton, xenon, radon, nitrogen, and carbon dioxide. The agent may include mixtures of various fluids, such as water in nitrogen, bromoform in polybromoethylene, various chlorofluorocarbons, nitrogen with argon, and others.

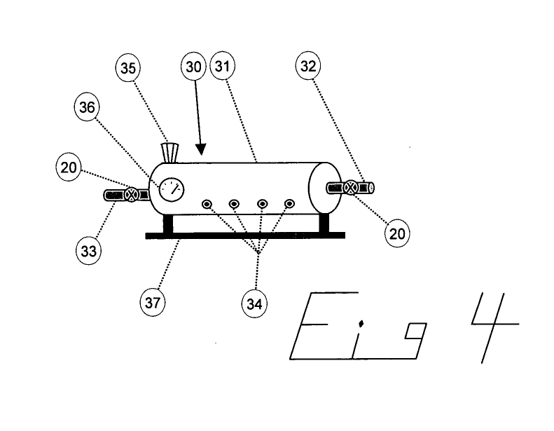

In the eventuality that more flexibility of use is required, the cryogenic firefighting and hazardous materials suppression apparatus may also include the use of a manifold as an extension of the tank or as a connection between multiple tanks. An embodiment of a manifold is shown in FIG. 4. The manifold 30 is a liquid tight enclosure 31 that has an inlet 32 operatively connected to a source of cryogenic fluid and at least one outlet 33 operatively connected to at least one supply conduit. Said inlet 32 and said outlet 33 may incorporate a valve 20. Said valve 20 is as described above. The manifold 30 may be any of a variety of shapes, including cylindrical, spherical, cubic, rectangular, and others. Additionally said manifold 30 acts as a secondary vessel for containing the agent. Typically said manifold 30 is insulated.

Said manifold 30 has additional connections 34, that may be used for inlets, outlets, and as sensing points for remote pressure or temperature readouts. Additionally said manifold 30 incorporates a pressure relief valve 35. Additionally said manifold 30 often has a pressure gauge 36. Said manifold 30 incorporates a mounting frame 37 often using bolts or welds to fasten the manifold to a holder of some type. An example of a holder may be a free standing frame, or a wheeled carriage, or a cradle in a motorized vehicle. Typically the manifold 30 is brought to the scene of an emergency by a vehicle and connected to a variety of tanks and hoses for utilization.

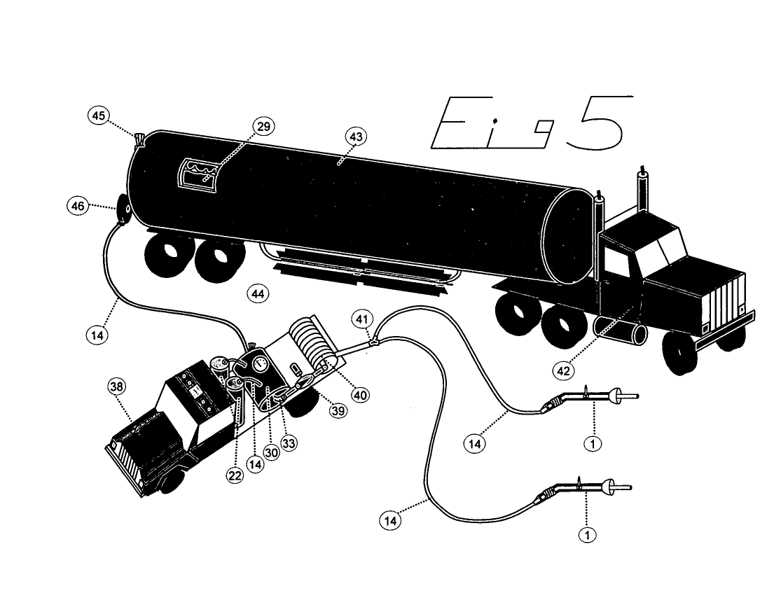

An embodiment of the cryogenic firefighting and hazardous materials suppression system is shown, in FIG. 5. This embodiment is built upon a vehicle 38 that supports a manifold 30. Said vehicle 38 includes space for operators and a variety of vehicle right of way equipment such as lights and sirens. Said vehicle 38 may be any of a family of vehicles, including cars, trucks, all terrain vehicles (ATVs), boats, helicopters, airplanes, and spaceships. In an embodiment the manifold 30 is a cylinder. The manifold 30 is shown connected to two tanks 22. Each of the tanks 22 is as described in FIG. 3. The tank 22 manual shut off valve 20 is connected through a cryogenic fluid supply conduit 14 to the manifold 30. The manifold 30 is as described in FIG. 4. The manifold outlet 33 incorporates a manual shutoff valve. An optional component is that of a pump 39, said pump 39 mounted in such a way that the manifold outlet 33 is the inlet to the pump 39, and the outlet of the pump 39 is into the fluid delivery system. The manifold outlet 33 is connected to a hose reel 40 upon which the cryogenic hose 14 is typically stored. The hose reel 40 may have one or more hoses 14 attached for delivery of the agent 29.

The cryogenic hose 14 is connected to at least one cryogenic gun 1. The cryogenic gun 1 is as described in FIG. 1. More than one cryogenic gun 1 may be connected to the hose 14 through use of a fitting 41. Said fitting 41 may be a Y type, a T type, a Cross type, or any of several other fittings, having multiple passageways throughout the fitting, to allow the connection of multiple hoses. In this embodiment, a Y type fitting 41 is shown.

The usage of a manifold 30 increases the overall capacity of said inert cryogenic firefighting and hazardous materials suppression system by enabling the use of more and larger supply tanks. Economies of scale, via utilization of space and convenience, preclude the use of more than several small tanks 22, and as such, dictate the use of a large single tank 43 when a large capacity is required. A single large tank 43 is shown as part of a commercial semi-truck 42 and trailer tank 43. The large tank 43 typically has capacities for storage of the agent 29 of 2000 gallons to over 10,000 gallons. The tank 43 is typically made of steel or stainless steel. The tank 43 is shown to be double walled. The tank 43 is insulated with vacuum insulation or other thick insulation such as ceramic blankets. The insulation is covered by a layer of metal. The tank 43 is equipped with a pressure builder circuit 44 to assist in delivering the agent 29. The tank 43 incorporates a safety relief valve 45. The tank has a pump 46 to transfer the agent into the delivery hose 14 at a specified delivery pressure and flow rate. The pump 46 may also have a variety of valves and gauges attached to monitor and control the flow of the agent 29. The tank 43 delivery hose 14 is attached to the manifold inlet 32.

Various embodiments of the cryogenic firefighting and hazardous materials suppression apparatus and system have been described. These descriptions should not be seen as any sort of limitation to the invention. A variety of modifications to these described apparatus and system may be accomplished without departing from the spirit and scope of this invention. This includes various methods for mounting the cryogenic fire fighting and hazardous materials suppression apparatus on any of a variety of vehicles as well as various methods for securing the vessel, the supply conduit, and the dispensing device to the vehicle, including inside the vehicle, outside the vehicle, or being disposed through the wall of the vehicle. Additionally the components may be mounted on separate vehicles and attached with removable connectors.

The cryogenic firefighting and hazardous materials suppression system includes a usage methodology. This methodology is the process of using the above described apparatus in such a fashion as to be safe, efficient, and rapidly extinguish fires and suppress hazardous materials spills. One skilled in the art of firefighting and hazardous incident control may rearrange, add to, subtract from, or otherwise modify the following steps while staying within the scope of this invention. Said methodology includes at least the following steps:

The tank(s) are filled with the agent. Said agent may be any one of many inert cryogenic liquids. The tank is mounted onto a vehicle or truck and secured. The hose and cryogenic gun are connected to the tank and then secured to the vehicle and stored. The liquid delivery valve on the tank, the pressure building valve, and the gun valve are all in the closed position. Upon the occurrence of a hazardous materials emergency, such as a fire or spill, the cryogenic firefighting and hazardous materials suppression apparatus is conveyed to the scene by at least one operator. When the emergency scene is reached, the gun and hose are deployed. The tank liquid supply valve and the pressure building valve are both turned on. The operator carries the gun toward the fire or spill. When a suitable distance is reached, the operator aims the gun at the center of the fire or at the source of the leak, opens the gun valve, and dispenses the inert cryogenic liquid onto the target. After the fire is extinguished or the spill is frozen, the gun valve is shut. Any additional cleanup work is performed at this point, including collection of the spilled material into a suitable container. Once the hazardous materials fire of spill has been successfully extinguished or contained, the tank liquid delivery valve and the pressure building valve are closed, and the hose and gun are stored. The tank is easily refilled with the agent.

When applied to a fire, the agent, which may be an inert cryogenic liquid immediately cools the burning substance, through the endothermic process of boiling, to form an inert gas. This inert gas is very cold and heavier than air. The inert gas stays close to the target and excludes oxygen from the immediate vicinity of the fire. The simultaneous cooling and asphyxiation of the fire results in rapid quenching. Once the fire is out, any additional cryogenic liquid that is sprayed continues to cool the materials involved. After the cryogenic gun is shut off, any residual cryogenic liquid simply evaporates, cleaning itself up from the fire scene and leaving no residue behind.

When applied to a hazardous material spill, the agent, which may be a cryogenic liquid freezes the spilled material and the crack or hole through which the spill is flowing. The cryogenic liquid stream cools the walls of the container of hazardous materials such that the material inside freezes and forms a blockage at the crack, thereby stopping the spill. Once the spill has frozen shut, a more permanent patch is applied to the compromised area. Additionally, the spilled material is frozen into a solid and can easily be collected into a suitable container.

This novel cryogenic firefighting and hazardous materials suppression apparatus has many benefits when compared to the current state of the art firefighting equipment. Through the use of an inert cryogenic liquid as the agent, many more fires can be put out than with just water or foam. Magnesium, phosphorus, powdered metals, pyrophoric chemicals, and BLEVE (Boiling Liquid Expanding Vapor Explosion) fires are unstoppable today, but can be frozen and quenched by the current invention. The inert cryogenic agent leaves no residue on the materials involved in the fire, while water makes books and computers wet and ruined, and foam makes everything it touches sticky and gooey, and dry powder chemical makes a great powdery mess of nasty dust. The inert cryogenic agent boils off to form a naturally occurring gas and does not pollute nor have negative impacts on the environment. Other agents, including Halon, are toxic and damaging to the environment. This novel cryogenic firefighting and hazardous materials suppression system is easy to use. It requires little retraining of the firefighters who will operate it. The apparatus is ambidextrous. The apparatus is made of the highest quality materials and is designed to function reliably, without failure, for many years of operation, while typically foam equipment and water hoses wear out within a couple years. The apparatus is unique in its simplicity such that it can be wholly operated by one person. This is in contrast to current fire equipment that requires a team of four to eight personnel. The current invention is designed to be easily transportable by a variety of vehicles, including trucks, boats, tanks, helicopters, airplanes, and spaceships. The inert cryogenic agents used are readily available in every state within the United States of America, as well as most other countries. The current apparatus does not require a fire hydrant to be used. In the winter, firefighters can spend a long time looking for hydrants buried in a snow drift. This current apparatus is less expensive than the current fire apparatus that are used for dispensing water and foam.

From the foregoing it will be understood that the apparatus and methodology embodying the present invention described above are well suited to provide the advantages set forth, and since many possible embodiments may be made of the various features of this invention and as the apparatus and system described herein may be varied in various parts, all without departing from the scope of the invention, it is to be understood that all matter hereinbefore described and shown in the accompanying drawings is to be construed as illustrative and that in certain circumstances, some of the features of the present invention may be used without a corresponding use of other features, all without departing from the scope of this invention.

1. A cryogenic fluid dispensing device comprising:
a hollow cylindrical body having a first end and a second end;
means for mounting a cryogenic fluid supply conduit to the first end;
a dispensing nozzle mounted to the second end;
a valve positioned in the hollow cylindrical body between the first end and the second end; and
a thermally insulating barrier at least partially surrounding the hollow cylindrical body.

2. The device as recited in claim 1, further comprising at least one handle mounted about the hollow cylindrical body.

3. The device as recited in claim 1, further comprising a shield mounted to the hollow cylindrical body between the valve and the nozzle, the shield adapted to at least partially protect the operator from the dispensed fluid.

4. The device as recited in claim 1, further comprising at least one adhesive layer between the hollow cylindrical body and the thermally insulating barrier.

5. The device as recited in claim 1, further comprising a protective sheathing mounted at least partially about the thermally insulating barrier.

6. The device as recited in claim 5, further comprising a rigid shell mounted at least partially about the protective sheathing.

7. The device as recited in claim 3, wherein the shield is one of flat, hemispherical, conical and pyramidal.

8. The device as recited in claim 1, wherein the device comprises a hand-held device.

9. The device as recited in claim 1, wherein the device comprises an inert cryogenic fluid dispensing device.

10. The device as recited in claim 1, wherein the device is adapted to dispense at least one fluid having a boiling point of at most −34 degrees C.

11. A cryogenic fluid dispensing system comprising:
a source of cryogenic fluid;
at least one supply conduit having a first end operatively connected to the source of cryogenic fluid and a second end;
at least one cryogenic fluid dispensing device comprising:
a hollow cylindrical body having a first end operatively connected to the second end of the supply conduit and a second end;
a dispensing nozzle mounted to the second end;
a valve positioned in the hollow cylindrical body between the first end and the second end; and
a thermally insulating barrier at least partially surrounding the hollow cylindrical body.

12. The system as recited in claim 11, further comprising at least one manifold having an inlet operatively connected to the source of cryogenic fluid and at least one outlet operatively connected to the at least one supply conduit.

13. The system as recited in claim 11, wherein the source of cryogenic fluid is mobile.

14. The system as recited in claim 11, wherein the source of cryogenic fluid is pressurized.

15. The system as recited in claim 11, wherein the at least one cryogenic fluid dispensing device comprises at least one hand-held device.

16. A method for dispensing a cryogenic fluid upon a target, the method comprising:
providing a source of cryogenic fluid;
providing a cryogenic fluid dispensing device comprising:
a hollow cylindrical body having a first end operatively connected to the source of cryogenic fluid and a second end;
a dispensing nozzle mounted to the second end; and
a valve positioned in the hollow cylindrical body between the first end and the second end;
supplying a flow of cryogenic fluid from the source of cryogenic fluid to the cryogenic fluid dispensing device;
controlling the flow of cryogenic fluid through the dispensing device by means of the valve; and
directing the flow of fluid out of the dispensing nozzle toward the target.

17. The method as recited in claim 16, wherein the target comprises one of a fire and a hazardous material.

18. The method as recited in claim 16, wherein the source of cryogenic fluid comprises a pressurized source, and wherein the method further comprises controlling the pressure of the fluid within the dispensing device.

19. The method as recited in claim 16, wherein directing the flow toward the target comprises manually directing the flow of fluid toward the target.

20. The method as recited in claim 16, wherein the method comprises a method of dispensing inert cryogenic fluid.
